(19) United States
(12) Patent Application Publication
(10) Pub. No.: US 2026/0169552 A1
(43) Pub. Date: Jun. 18, 2026

(54) FOVEATED IMAGING

(71) Applicant: QUALCOMM Incorporated, San Diego, CA (US)

(72) Inventors: Abhijeet DEY, Bengaluru (IN); Shrey Shailesh GADIYA, Bengaluru (IN); Varun BANSAL, New Delhi (IN); Saurabh AGGARWAL, Bengaluru (IN)

(21) Appl. No.: 18/979,387

(22) Filed: Dec. 12, 2024

(51) Int. Cl. G06F 3/01; G06T 7/11; G06T 19/00

(52) U.S. Cl. CPC G06F 3/013; G06T 7/11; G06T 19/00; G06T 2200/28; G06T 2207/20016; G06T 2207/20104; G06T 2210/12; G06T 2210/36

(57) ABSTRACT

Systems and techniques are described herein for foveated imaging. For instance, a method for foveated imaging is provided. The method may include obtaining foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; determining that a user is gazing at virtual content; based on determining that the user is gazing at the virtual content, disabling output of the first image data; and outputting the second image data to a computing device.

### TECHNICAL FIELD

The present disclosure generally relates to foveated imaging. For example, aspects of the present disclosure include systems and techniques for capturing, storing, transferring, processing, and/or displaying foveated image data.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment. For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

A foveated image is an image with different resolutions in different regions within the image. For example, a foveated image may include a highest resolution in a region of interest (ROI) and one or more lower-resolution regions around the ROI (e.g., in one or more “peripheral regions”).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for foveated imaging. According to at least one example, a method is provided for foveated imaging. The method includes: obtaining foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; determining that a user is gazing at virtual content; based on determining that the user is gazing at the virtual content, disabling output of the first image data; and outputting the second image data to a computing device.

In another example, an apparatus for foveated imaging is provided that includes at least one memory and at least one processor (e.g., configured in circuitry) coupled to the at least one memory. The at least one processor configured to: obtain foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; determine that a user is gazing at virtual content; based on determining that the user is gazing at the virtual content, disable output of the first image data; and output the second image data to a computing device.

In another example, a non-transitory computer-readable medium is provided that has stored thereon instructions that, when executed by one or more processors, cause the one or more processors to: obtain foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; determine that a user is gazing at virtual content; based on determining that the user is gazing at the virtual content, disable output of the first image data; and output the second image data to a computing device.

In another example, an apparatus for foveated imaging is provided. The apparatus includes: means for obtaining foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; means for determining that a user is gazing at virtual content; means for based on determining that the user is gazing at the virtual content, disabling output of the first image data; and means for outputting the second image data to a computing device.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example XR system, according to aspects of the disclosure;

FIG. 3 is a block diagram illustrating an example system to illustrate a video-see-through (VST) dataflow;

FIG. 4 includes an example foveated image;

FIG. 5A is a diagram of an example apparatus for capturing facial images of a user;

FIG. 5B is a diagram of another example apparatus for capturing facial images of a user;

FIG. 6 includes an example facial image that may be used for eye tracking;

FIG. 7 includes an example image of virtual content overlaid onto an image of a scene;

FIG. 8 includes an example image of virtual content overlaid onto an image of a scene;

FIG. 9 is a block diagram of a system for processing foveated image data, according to various aspects of the present disclosure;

FIG. 10 is a block diagram illustrating an example system for processing foveated image data, according to various aspects of the present disclosure;

FIG. 11 is a flow diagram illustrating an example process for extended reality, in accordance with aspects of the present disclosure;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As noted previously, a foveated image may have different resolutions in different regions within the image. For example, a foveated image may include a highest resolution in a region of interest (ROI) and one or more lower-resolution regions around the ROI (e.g., in one or more “peripheral regions”).

A foveated-image sensor can be configured to capture an image of an ROI of a field of view in high resolution. The image may be referred to as a “fovea region” or an “ROI.” The foveated-image sensor may also capture another image of the full field of view at a lower resolution. The portion of the lower-resolution image that is outside the ROI may be referred to as the peripheral region. The image of the ROI may be inset into the other image of the peripheral region. The combine image may be referred to as a foveated image. In some aspects, foveated-image capture may operate at multiple tiers of resolution, for example, with an ROI at a highest resolution, a first-tier peripheral region (e.g., outside the ROI) at a second-highest resolution, a second-tier peripheral region (e.g., outside the first-tier peripheral region) at a third-highest resolution, etc.

Additionally or alternatively, a processor can render or process a foveated image with image data of an ROI at a higher resolution and image data of a peripheral region at a lower resolution. For example, an image sensor may load image data into memory (the image data may be foveated image data or images data with all the pixels at the same resolution). When processing the image data, an image processor may retrieve the image data from the memory at different resolutions. For example, the image processor may retrieve pixels of an ROI at a first resolution and pixels of a peripheral region at a second resolution. The image processor may process the retrieved pixels. Additionally or alternatively, an image processor may perform different image processing techniques, or a different number of processing operations for different regions. For example, the image processor may process pixels of an ROI using a first number of image-processing operations and pixels of a peripheral region using a second number of image-processing operations.

Additionally or alternatively, a processor, a display driver, and/or a display may display foveated image with image data of an ROI displayed at a higher resolution and image data of a peripheral region displayed at a lower resolution. For example, a display driver may receive images data from an image processor. The display driver may cause a display device to display pixels in an ROI to be displayed at a first resolution and pixels in a peripheral region to be displayed at a second resolution.

XR applications may benefit from foveated image capturing, rendering, processing, and/or displaying. For example, some XR head-mounted displays (HMDs) may render, process, and/or display foveated image data, (e.g., virtual content to be displayed at the HMD) in a foveated manner. The image data may be rendered, processed, and/or displayed at different qualities and/or resolutions at different regions of the image data. For example, the image data may be rendered at a highest resolution and/or quality in an ROI and at a lower resolution and/or quality outside the ROI.

As an example, some XR HMDs may implement video see through (VST). In VST, an XR HMD may capture images of a field of view of a user and display the images to the user as if the user were viewing the field of view directly. While displaying the images of the field of view, the XR HMD may alter or augment the images providing the user with an altered or augmented view of the environment of the user (e.g., providing the user with an XR experience). VST may benefit from foveated image capture, foveated image processing, foveated image rendering and/or foveated image display.

Foveated image capturing, rendering, processing, and/or displaying may be useful in XR because foveated-image sensing, rendering, processing, and/or displaying may allow an XR HMD to conserve computational resources (e.g., power, processing time, communication bandwidth etc.). For example, a foveated image of a field of view (or a smaller area) may be smaller in data size than a full-resolution image of the same field of view (or the same smaller area) because the peripheral region of the foveated image may have lower resolution and may be stored using less data. Thus, capturing, storing, processing, rendering, and/or displaying a foveated image rather than a full-resolution image may conserve computational resources.

Some devices may capture, process, render, and/or display foveated images based on a gaze of a user. For example, some devices (e.g., XR HMDs) may determine a gaze of a view (e.g., where the viewer is gazing within an image frame) and determine an ROI for foveated imaging based on the gaze. The device may then capture, render, process, and/or display image data (e.g., foveated image data) to have the highest resolution in the ROI and lower resolution outside the ROI (e.g., at “peripheral regions”).

In VST, in some cases, a user's eye gaze may be focused on virtual content (like a virtual desktop or virtual movie screen). For example, an XR device may capture images of a scene and display the images of the scene at a display (e.g., implementing VST). Additionally, the XR device may display virtual content, such as a virtual desktop or virtual movie screen. For example, a user may be watching a movie on a virtual movie screen that is anchored to a wall (e.g., the virtual movie screen is overlaid onto the user's view of a wall). Depending on size and shape of the virtual content, the virtual content may fill an entirety or a majority of an ROI (or both an ROI and a middle region). The size of the ROI may be determined based on an ability of a person to focus on and resolve pixels in the ROI.

In cases in which virtual content substantially fills the ROI, computational resources used in storing, transferring, and/or processing VST pixels of the ROI (e.g., pixels of the ROI captured by a scene-facing camera), may be wasted. For example, virtual content may be displayed in place of the VST pixels of the ROI.

Systems, apparatuses, methods (also referred to as processes), and computer-readable media (collectively referred to herein as “systems and techniques”) are described herein for foveated imaging. For example, the systems and techniques described herein may determine instances where computational resources may be conserved by not capturing, storing, transferring, and/or processing pixels of one or more regions of an image based on virtual content replacing such pixels when the image is to be displayed. The systems and techniques may determine, based on virtual content filling a threshold portion of an ROI, to not capture, store, transfer and/or process VST pixels of the ROI. Accordingly, the systems and techniques may conserve computational resources without impacting user experience. The systems and techniques may improve power and/or bandwidth usage for VST use cases without impacting user-experience.

Various aspects of the application will be described with respect to the figures below.

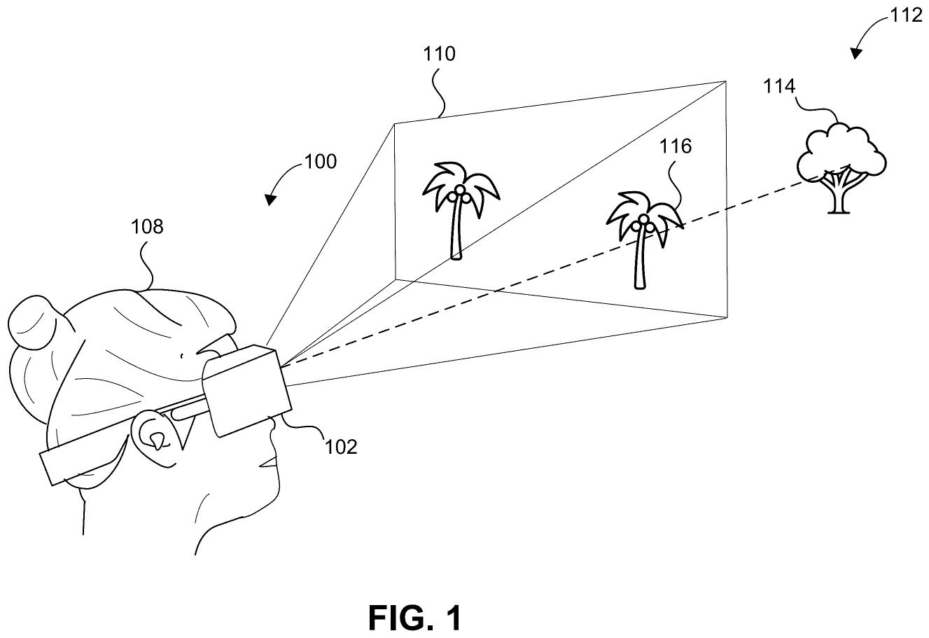

FIG. 1 is a diagram illustrating an example extended-reality (XR) system 100, according to aspects of the disclosure. As shown, XR system 100 includes an XR device 102. XR device 102 may implement, as examples, image-capture, object-detection, object-tracking, gaze-tracking, view-tracking, localization (e.g., determining a location of XR device 102), pose-tracking (e.g., tracking a pose of XR device 102 and/or a pose of one or more objects in scene 112), content-generation, content-rendering, computational, communicational, and/or display aspects of extended reality, including virtual reality (VR), augmented reality (AR), and/or mixed reality (MR).

For example, XR device 102 may include one or more scene-facing cameras that may capture images of a scene 112 in which a user 108 uses XR device 102. XR device 102 may detect and/or track objects (e.g., object 114) in scene 112 based on the images of scene 112. In some aspects, XR device 102 may include one or more user-facing cameras that may capture images of eyes of user 108. XR device 102 may determine a gaze of user 108 based on the images of user 108. In some aspects, XR device 102 may determine an object of interest (e.g., object 114) in scene 112 (e.g., based on the gaze of user 108, based on object recognition, and/or based on a received indication regarding object 114). XR device 102 may obtain and/or render XR content 116 (e.g., text, images, and/or video) for display at XR device 102. XR device 102 may display XR content 116 to user 108 (e.g., within a field of view 110 of user 108). In some aspects, XR content 116 may be based on and/or anchored to points in scene 112. For example, XR content 116 may be, or may include, an altered version of object 114 (e.g., based on an XR application running at XR device 102) anchored to object 114 in scene 112. The XR application may provide user 108 with an XR experience by altering scene 112 in field of view 110 of user 108. In some aspects, XR device 102 may display XR content 116 in relation to the view of user 108 of the object of interest. For example, XR device 102 may overlay XR content 116 onto object 114 in field of view 110. In any case, XR device 102 may overlay XR content 116 (whether related to object 114 or not) onto the view of user 108 of scene 112. For example, object 114 may be a cherry tree. Based on an XR application running at XR device 102, XR device 102 may anchor XR content 116, which may be a palm tree, to object 114 such that in the view of user 108, user 108 sees XR content 116 (the palm tree) and not object 114 (the cherry tree).

In a “see-through” or “transparent” configuration, XR device 102 may include a transparent surface (e.g., optical glass) such that XR content 116 may be displayed on (e.g., by being projected onto) the transparent surface to overlay the view of user 108 of scene 112 as viewed through the transparent surface. In a “pass-through” configuration or a “video see-through” configuration, XR device 102 may include a scene-facing camera that may capture images of scene 112. XR device 102 may display images or video of scene 112, as captured by the scene-facing camera, and XR content 116 overlaid on the images or video of scene 112.

In various examples, XR device 102 may be, or may include, a head-mounted device (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, display, and/or smart glass).

In some aspects, XR device 102 may be, or may include, two or more devices. For example, XR device 102 may include a display device and a processing device. The display device may capture and/or generate data, such as image data (e.g., from user-facing cameras and/or scene-facing cameras) and/or motion data (from an inertial measurement unit (IMU)). The display device may provide the data to the processing device, for example, through a wireless connection between the display device and the processing device. The processing device may process the data and/or other data (e.g., data received from another source). Further, the processing unit may generate (or obtain) XR content 116 to be displayed at the display device. The processing device may provide the generated XR content 116 to the display device, for example, through the wireless connection. And the display device may display XR content 116 in field of view 110 of user 108.

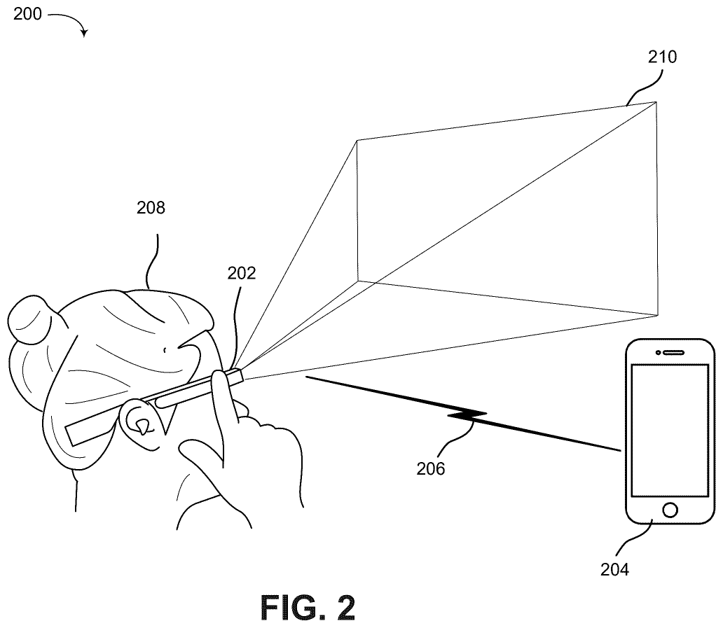

FIG. 2 is a diagram illustrating an example extended reality (XR) system 200, according to aspects of the disclosure. As shown, XR system 200 includes an XR device 202, a companion device 204, and a communication link 206 between XR device 202 and companion device 204. XR device 202 may implement, as examples, image-capture, view-tracking, and/or display aspects of extended reality, including virtual reality (VR), augmented reality (AR), and/or mixed reality (MR). For example, XR device 202 may include one or more scene-facing cameras that may capture images of a scene in which a user 208 uses XR device 202. Further, XR device 202 may include one or more user-facing cameras that may capture images of eyes of user 208. XR device 202 may provide the images of the scene and/or the images of user 208 to companion device 204 (e.g., via communication link 206). Additionally, XR device 202 may include one or more inertial measurement units (IMUs) that may measure inertial data. XR device 202 may provide the inertial data to companion device 204.

Companion device 204 may implement computing aspects of extended reality, including, as examples, object detection, gaze tracking, localization, mapping, information gathering and/or information generation. For example, companion device 204 may receive images of the scene and/or of the eyes of user 208. Companion device 204 may detect objects in the scene based on received images of the scene. Further, companion device 204 may determine that the gaze of user 208 based on received images of user 208 (e.g., of eyes of user 208). In some aspects, companion device 204 may obtain inertial data and determine a location and/or pose of XR device 202 based on the inertial data. Additionally or alternatively, companion device 204 may determine a location and/or pose of XR device 202 based on images captured by scene-facing cameras of XR device 202 (e.g., using simultaneous localization and mapping (SLAM) techniques). Companion device 204 may obtain and/or render information (e.g., text, images, and/or video based on the object of interest). Companion device 204 may provide the information to XR device 202 (e.g., via communication link 206). XR device 202 may display the information to a user 208 (e.g., within a field of view 210 of user 208).

XR device 202 may display the information to be viewed by a user 208 in field of view 210 of user 208. For example, in a “see-through” configuration, XR device 202 may include a transparent surface (e.g., optical glass) such that information may be displayed on (e.g., by being projected onto) the transparent surface to overlay the information onto the scene as viewed through the transparent surface. In a “pass-through” configuration or a “video see-through” (VST) configuration, XR device 202 may include a scene-facing camera that may capture images of the scene of user 208. XR device 202 may display images or video of the scene, as captured by the scene-facing camera, and information overlaid on the images or video of the scene.

In various examples, XR device 202 may be, or may include, a head-mounted display (HMD), a virtual reality headset, and/or smart glasses. XR device 202 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass). Companion device 204 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof. Communication link 206 may be a wireless connection according to any suitable wireless protocol, such as, for example, Institute of Electrical and Electronics Engineers (IEEE) 802.11 (Wi-Fi), IEEE 802.15, or Bluetooth®. In some cases, communication link 206 may be a direct wireless connection between XR device 202 and companion device 204. In other cases, communication link 206 may be through one or more intermediary devices, such as, for example, routers or switches and/or across a network.

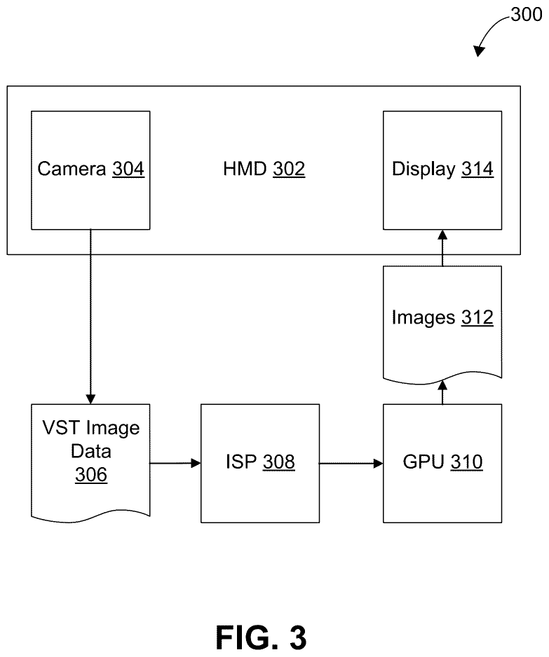

FIG. 3 is a block diagram illustrating an example system 300 to illustrate a video-see-through (VST) dataflow. For example, a camera 304 (e.g., a scene-facing camera) of a head-mounted device (HMD) 302 (such as XR system 100 or XR system 200) may capture VST image data 306 (e.g., images of a scene). VST image data 306 may be processed at an image signal processor (ISP) 308 and/or a graphics processing unit (GPU) 310 and the resulting processed images 312 may be displayed at a display 314 of HMD 302. In some aspects, ISP 308 and/or GPU 310 may be included in HMD 302. Additionally or alternatively, a separate computing device (such as companion device 204 of XR system 200) may include ISP 308 and/or GPU 310.

Processing image data at ISP 308, GPU 310, and/or other processors may consume computational resources (such as power and processing time). Additionally, communicating VST image data 306 to ISP 308, GPU 310, other processors, and display 314 may take communication bandwidth (and/or power). Communicating VST image data 306 may consume bandwidth in cases when ISP 308 and/or GPU 310 are part of a separate computing devices (such as companion device 204 of XR system 200).

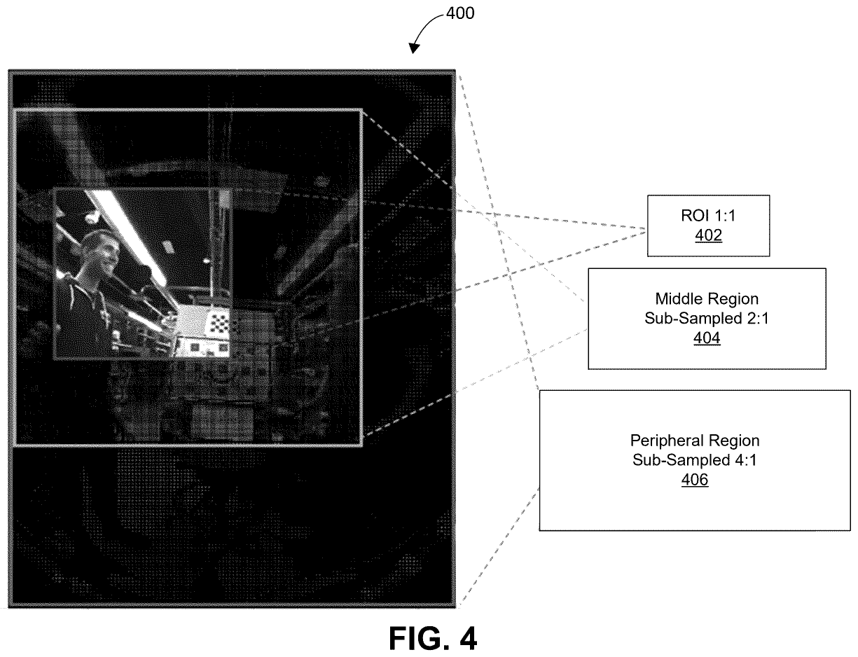

FIG. 4 includes an example foveated image 400. Foveated image 400 includes a region of interest (ROI) 402 having a first resolution. The first resolution may be described as a 1:1 resolution. For example, for every pixel captured by an image sensor, ROI 402 may include one pixel. Thus the resolution of ROI 402 may be the highest resolution that can be captured by the image sensor.

Foveated image 400 may additionally include middle region 404 which has a second resolution. The second resolution, for example, may be described as 2:1. For example, for every 2×2 block of pixels captured by the image sensor, middle region 404 may include one pixel. Thus middle region 404 may be subsampled (e.g., downsampled by a factor of two in two directions) relative to the highest resolution image data that can be captured by the image sensor. Thus, middle region 404 may have a resolution that is one quarter (e.g., half in each direction) of the resolution of image data at the highest resolution of the image sensor.

The size of ROI 402 and/or middle region 404 may be determined based on an ability of a person to focus on and resolve pixels in a region of the person's field of view. For example, the size of ROI 402 may be based on how well a person looking at ROI 402 is able to notice a lower resolution outside ROI 402. Similarly, the size of middle region 404 may be based on how well a person looking at middle region 404 is able to notice a lower resolution outside middle region 404.

Foveated image 400 may include additional middle areas and/or peripheral areas. For example, foveated image 400 includes peripheral region 406 which has a third resolution. The third resolution, for example, may be described as 4:1. For example, for every 4×4 block of pixels captured by the image sensor, peripheral region 406 may include one pixel. Thus peripheral region 406 may be subsampled (e.g., downsampled by a factor of four in both directions) relative to the highest resolution image data that can be captured by the image sensor. Thus, peripheral region 406 may have a resolution that is one sixteenth the resolution of image data at the highest resolution of the image sensor.

A foveated image, according to various aspects of the present disclosure, may have any number of ROIs and/or any number of middle regions and/or peripheral regions. The ROIs, middle regions, and/or peripheral regions may, or may not, be rectangular.

If a VST pipeline (such as system 300) uses foveated image data rather than full-resolution image data (e.g., image data including all the pixels captured by an image sensor), the VST pipeline may conserve computational resources. For example, by storing, processing, and transmitting foveated image data (e.g., foveated image 400), the VST pipeline may store, process, and transmit less data and may thereby conserve computational resources.

In some aspects, an ROI may be determined based on a gaze of a viewer of the display. For example, a gaze of a viewer of display 314 may be tracked and the position of ROI 402 within foveated image 400 may be determined based on the gaze. Because the viewer is gazing at ROI 402, and because ROI 402 has a full resolution, the user's experience may not be diminished by the lower resolution of middle region 404 and peripheral region 406.

Peripheral region 406 may include pixels (at the third resolution) for the full frame of foveated image 400. As such, peripheral region 406 may include pixels (at the third resolution) overlapping middle region 404 and ROI 402. Similarly, middle region 404 may include pixels (at the second resolution) for the full area of middle region 404. As such, middle region 404 may include pixels (at the second resolution) overlapping ROI 402.

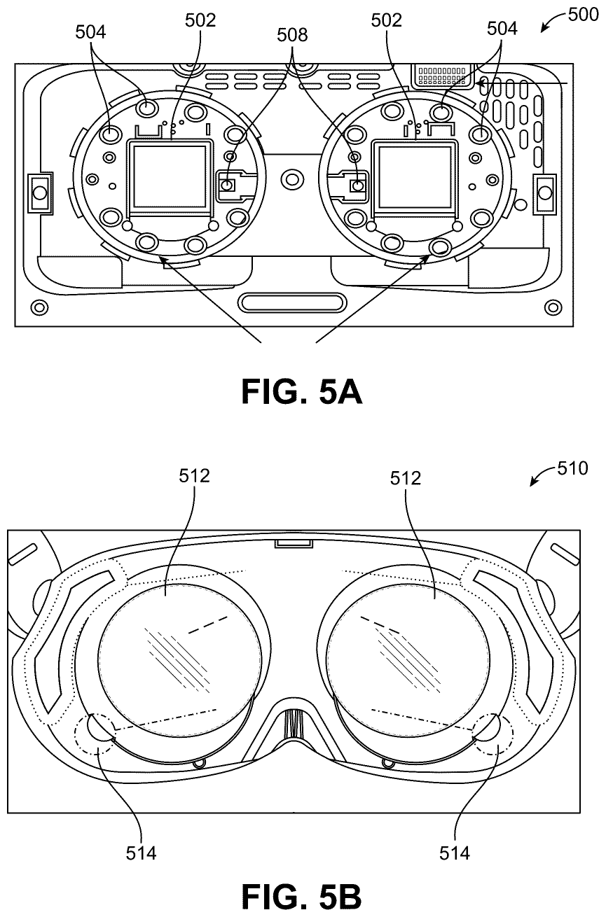

FIG. 5A is a diagram of an example apparatus 500 for capturing facial images of a user. Apparatus 500 may be an HMD, for example, a XR device. Apparatus 500 includes two displays 502. When apparatus 500 is worn by a user, displays 502 may be proximate to eyes of the user. Additionally, apparatus 500 includes cameras 508, which are positioned such that when apparatus 500 is worn by a user, cameras 508 are positioned and angled to capture images of eyes of the user. Apparatus 500 also includes light sources 504, which are positioned such that when apparatus 500 is worn by a user, light sources 504 are positioned to illuminate the eyes of the user.

In the present disclosure, references to light and illumination include electromagnetic radiation of any wavelength, including as examples, ultraviolet UV, visible, near infrared (NIR), and infrared (IR). Examples of light sources include light-emitting diodes (LEDs), edge-emitting lasers (EELs), and vertical-cavity surface-emitting lasers (VCSELs).

In the present disclosure, references to “eyes” should be understood to apply to one eye or two eyes. For example, in some aspects, a device may capture an images of one eye of a user. Additionally, references to capturing “images of eyes,” “eye images,” “facial images” “images of eyes and/or face,” and like terms, should be understood to apply to capturing images of eyes and/or other portions of a user's face, such as eyelids, eyebrows, brow, nose, cheeks, lips, mouth, etc.

FIG. 5B is a diagram of another example apparatus 510 for capturing facial images of a user. Apparatus 510 includes lenses 512 (which may be referred to as “pancake lenses”). A user may view a display through lenses 512. For example, lenses 512 may focus light from the display to eyes of the user. Additionally, apparatus 510 includes cameras 514 which may capture images of eyes of the user. Apparatus 510 may also include light sources (not labelled in FIG. 5B) that may illuminate eyes of the user.

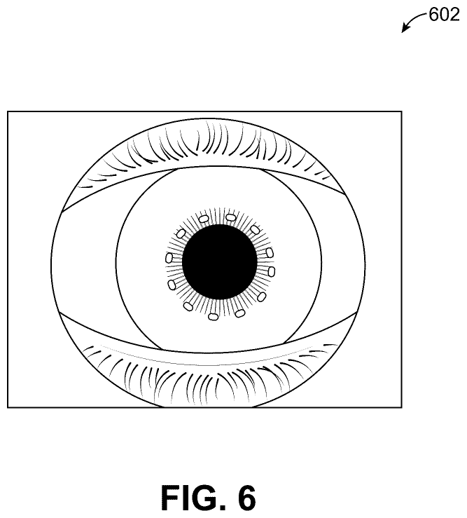

FIG. 6 includes example facial image that may be used for eye tracking. Eye tracking may involve tracking a user's gaze. Eye tracking may be use for gaze-based selection and/or foveation, among other tasks. Eye tracking may involve illuminating an eye with a pattern and comparing a pupil of the eye to the pattern. Additionally or alternatively, eye tracking may involve resolving shape of ring and pupil contour and using centers (e.g., a center of a pupil and a center of a reflected ring of illumination) for triangulation. For eye tracking, images captured from a “head-on view” may produce the best results. For example, an image captured along an optical axis of the eye may allow eye tracking to produce the best results. Additionally or alternatively, illuminating the eye along the optical axis may allow for the best results. Eye-tracking applications may be benefitted by capturing many images of the eye over time. For example, to have the current gaze information, it may be beneficial for an eye-tracker to capture many (e.g., 200) frames per second (fps). Image 602 is an example image of an eye that may be suitable for eye tracking.

In VST, in some cases, a user's eye gaze may be focused on virtual content (like a virtual desktop or virtual movie screen). For example, an XR device may capture images of a scene and display the images of the scene at a display (e.g., implementing VST). Additionally, the XR device may display virtual content, such as a virtual desktop or virtual movie screen. For example, a user may be watching a movie on a virtual movie screen that is anchored to a wall (e.g., the virtual movie screen is overlaid onto the user's view of a wall). Depending on size and shape of the virtual content, the virtual content may fill an entirety or a majority of an ROI (or both an ROI and a middle region).

In cases in which virtual content substantially fills the ROI, computational resources used in storing, transferring, and/or processing VST pixels of the ROI (e.g., pixels of the ROI captured by a scene-facing camera), may be wasted. For example, virtual content may be displayed in place of the VST pixels of the ROI.

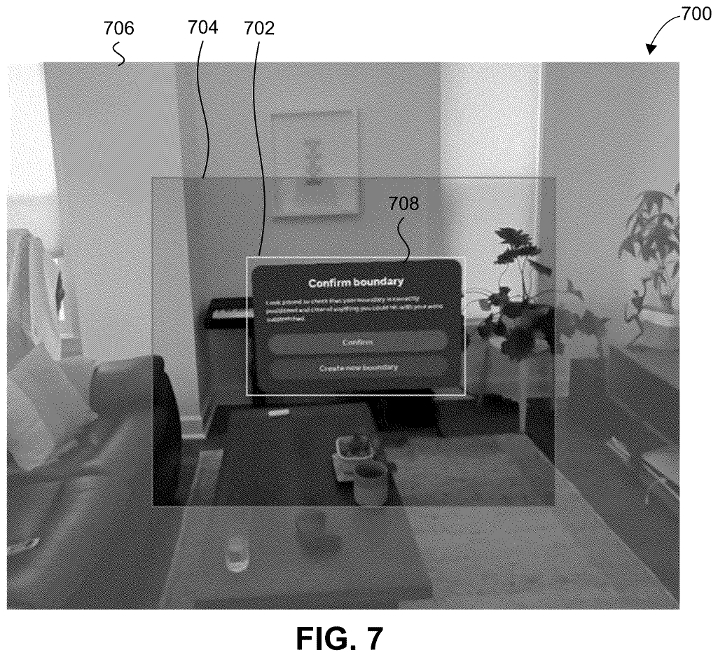

For example, FIG. 7 includes an example image 700 of virtual content 708 overlaid onto an image of a scene. Image 700 includes a ROI 702, a middle region 704, and a peripheral region 706. In the example of FIG. 7, virtual content 708 substantially fills ROI 702.

Because virtual content 708 substantially fills ROI 702, computational resources used in storing, transferring, and/or processing VST pixels of ROI 702 (e.g., pixels captured by a scene-facing camera that would fill ROI 702 if not replaced by virtual content 708) may be wasted. For example, most of the VST pixels of ROI 702 may not be displayed. For instance, according to a conventional VST pipeline, using image 700 as an example of VST image data 306, VST pixels of ROI 702 of image 700 may be processed at ISP 308 and/or GPU 310 but may not be displayed at display 314 (because the pixels of virtual content 708 may be displayed in place of the VST pixels of ROI 702). Computational resources used in processing, storing, and transferring VST pixels of ROI 702 from the camera at which the VST pixels are captured until the VST pixels are replaced by pixels of virtual content 708 are wasted.

The systems and techniques may determine instances where computational resources may be conserved by not capturing, storing, transferring, and/or processing VST pixels of one or more regions of an image based on virtual content replacing such VST pixels when the image is to be displayed. For example, the systems and techniques may determine, based on virtual content 708 filling a threshold portion of ROI 702, to not capture, store, transfer and/or process VST pixels of ROI 702. Accordingly, the systems and techniques may conserve computational resources without impacting user experience.

Because middle region 704 includes VST pixels (at lower resolution than ROI 702) that overlap with ROI 702, storing, transferring, and processing middle region 704 may conserve pixels (at the resolution of middle region 704) that are between virtual content 708 and the edges of ROI 702.

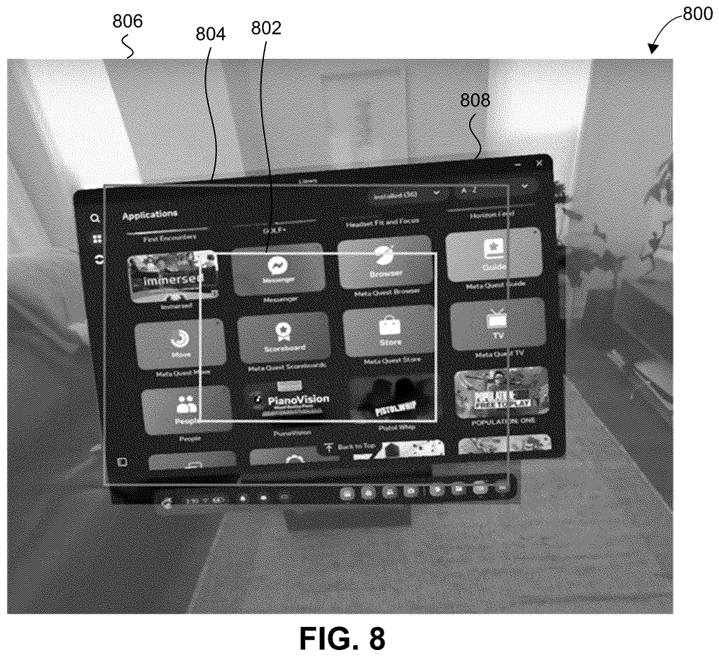

As another example, FIG. 8 includes an example image 800 of virtual content 808 overlaid onto an image of a scene. Image 800 includes a ROI 802, a middle region 804, and a peripheral region 806. In the example of FIG. 8, virtual content 808 substantially fills ROI 802 and middle region 804.

Because virtual content 808 substantially fills ROI 802 and middle region 804, computational resources used in storing, transferring, and/or processing VST pixels of ROI 802 and middle region 804 may be wasted. For example, most of the VST pixels of middle region 804 (and all the VST pixels of ROI 802) may not be displayed. For instance, according to a conventional VST pipeline, using image 800 as an example of VST image data 306, VST pixels of ROI 802 and middle region 804 of image 800 may be processed at ISP 308 and/or GPU 310 but may not be displayed at display 314 (because pixels of virtual content 808 may be displayed in place of the VST pixels of ROI 802 and middle region 804). Computational resources used in processing, storing, and transferring VST pixels of ROI 802 and middle region 804 from the camera at which the VST pixels are captured until the VST pixels are replaced by pixels of virtual content 808 are wasted.

The systems and techniques may determine, based on virtual content 808 filling a threshold portion of middle region 804, to not capture, store, transfer and/or process VST pixels of middle region 804. Accordingly, the systems and techniques may conserve computational resources without impacting user experience.

Because peripheral region 806 includes VST pixels (at lower resolution than middle region 804) that overlap with middle region 804, storing, transferring, and processing peripheral region 806 may conserve pixels (at the resolution of peripheral region 806) that are between virtual content 808 and the edges of middle region 804.

FIG. 7 and FIG. 8 provide examples of interfaces as virtual content. The systems and techniques operate with other forms of virtual content, such as, for example, image data (e.g., a photo gallery), video data (e.g., a movie), interactive data (e.g., a virtual desktop or application), representations of characters or objects, etc.

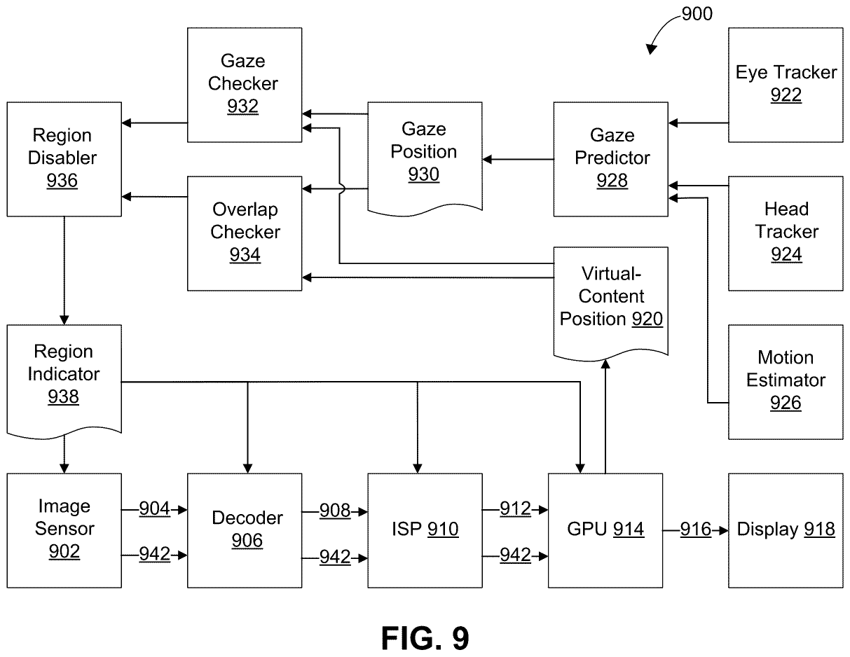

FIG. 9 is a block diagram of a system 900 for processing foveated image data, according to various aspects of the present disclosure. In general, system 900 may disable capturing, storing, transfer, and/or processing of image data of based on virtual content overlapping the image data.

For example, an image sensor 902 may capture VST image data 904. Image sensor 902 may be, or may include, a scene-facing image sensor of an HMD. Image sensor 902 may be configured to capture foveated image data. For example, image sensor 902 may be configured to capture image data representing a first field of view (FOV) of a scene at first resolution, image data representing a second FOV (e.g., smaller than the first FOV) of the scene at a second resolution (e.g., higher than the first resolution), and image data representing an ROI (e.g., smaller than the smaller FOV) of the scene at a third resolution (e.g., higher than the second resolution). Foveated image 400 of FIG. 4 is an example of VST image data 904.

A decoder 906 may decode VST image data 904 and provide decoded image data 908 to an ISP 910. Decoder 906 may be, or may include, a Mobile Industry Processor Interface (MIPI) camera serial interface (CSI) decoder.

ISP 910 may process the decoded image data 908 and provide processed image data 912 to GPU 914. To process VST image data 904, ISP 910 may perform operations, such as for example, noise reduction, sharpening, tone mapping, and/or color correction.

GPU 914 may process image data 912 and provide image data 916 to display 918. GPU 914 may, among other things, perform final frame composition (e.g., blending ROI, middle, and periphery regions, any additional denoising/color correction or any other warping operations) and/or virtual content to processed image data 912 to generate image data 916. For example, GPU 914 may add virtual content 708 to image 700. As another example, GPU 914 may add virtual content 808 to image 800.

Additionally, GPU 914 may generate virtual-content position 920. Virtual-content position 920 may indicate a position of virtual content within image data 916.

Display 918 may display image data 916 to a viewer. Display 918 may be a display of an HMD, such as XR device 102 or XR device 202.

An eye tracker 922 may track a gaze of the viewer of display 918. Eye tracker 922 may use images from one or more user-facing cameras. For example, eye tracker 922 may use images such as image 602 of FIG. 6 as captured by camera such as cameras 508 of FIG. 5A and/or cameras 514 of FIG. 5B.

A head tracker 924 may track a head of the viewer of display 918. A motion estimator 926 may track motion of display 918. Head tracker 924 and/or motion estimator 926 may use data from one or more inertial measurement units (IMUs) of the HMD.

Gaze predictor 928 may predict a gaze of the viewer based on the tracked gaze of the viewer, the tracked head of the viewer, and the tracked motion of display 918. Gaze predictor 928 may generate gaze position 930 which indicates a position of a center of the predicted gaze and/or a position of an ROI based on the predicted gaze. Additionally or alternatively, gaze position 930 may include positions of one or more peripheral or middle regions. For example, gaze position 930 may indicate corners of ROI 402 and middle region 404 relative to foveated image 400. Gaze position 930 may be relative to image data 916.

Gaze checker 932 may perform a temporal check on the gaze and the virtual content. For example, gaze checker 932 may measures a duration of time for which the gaze is on virtual content (e.g., based on a relationship between gaze position 930 and virtual-content position 920). For instance, gaze checker 932 may determine a duration of time for which a gaze center of gaze position 930 is within an area of virtual-content position 920. Additionally or alternatively, gaze checker 932 may determine a duration of time during which an ROI of gaze checker 932 overlaps with virtual-content position 920. When the duration of time exceeds a configurable time threshold, gaze checker 932 may determine that the user is gazing at the virtual content. In some aspects, the configurable time threshold (for the temporal check) can be determined through machine learning by analyzing the viewer's attention span to virtual content as displayed by display 918.

Overlap checker 934 may perform a spatial check on the gaze and the virtual content. For example, overlap checker 934 may determine an amount of overlap between the virtual content and an ROI and/or middle region. If the amount of overlap crosses a configurable overlap threshold, overlap checker 934 may determine that the ROI and/or middle regions are not needed (e.g., based on the ROI and/or middle region being replaced by virtual content in image data 916). In some aspects, the configurable overlap-threshold (for the spatial check) can be determined based on trade-off between image-quality and computational-resource savings.

Based on the temporal and/or the spatial check, region disabler 936 may determine to disable (or not) output of one or more regions (e.g., an ROI and/or middle region) of VST image data 904. Region disabler 936 may generate region indicator 938 which may indicate whether to disable (or not) output of one or more regions of VST image data 904. Region disabler 936 may provide region indicator 938 to image sensor 902.

Region disabler 936 may determine to disable output of one or more regions of VST image data 904. For example, region disabler 936 may determine to cause image sensor 902 to not output one or more regions (e.g., an ROI and one or more middle regions) of VST image data 904. Additionally or alternatively, region disabler 936 may determine to not capture, store, transfer, transmit, or process one or more regions of VST image data 904. For example, region disabler 936 may determine to cause image sensor 902, decoder 906, ISP 910, and/or GPU 914 to not capture, store, transfer, transmit, or process one or more regions of VST image data 904. Region indicator 938 may be, or may include, an indication to not output, capture, store, transfer, transmit, or process one or more regions of VST image data 904.

Based on region indicator 938, image sensor 902 may then transmit or collapse one or more respective regions. For example, based on an indication in region indicator 938 to not output ROI 702, image sensor 902 may provide peripheral region 706 and middle region 704 (and not ROI 702) to decoder 906 as VST image data 904. As another example, based on an indication in region indicator 938 to not ROI 802 and output middle region 804, image sensor 902 may provide peripheral region 806 (and not middle region 804 or ROI 802) to decoder 906 as VST image data 904.

By not providing VST image data that will be replaced by virtual content, system 900 may conserve computational resources. For example, decoder 906 may conserve computational resources by not decoding regions of VST image data 904 that will be overlapped by virtual content in image data 916. Additionally, ISP 910 may conserve computational resources by not processing regions of decoded image data 908 that will be overlapped by virtual content in image data 916. Additionally, GPU 914 may conserve computational resources by not processing regions of processed image data 912 that will be overlapped by virtual content in image data 916.

In some aspects, decoder 906, ISP 910, and/or GPU 914 may gate clock or power of regions of image data (e.g., VST image data 904, decoded image data 908, and processed image data 912 respectively) that will be overlapped by virtual content in image data 916. For example, in some aspects, region disabler 936 may provide region indicator 938 to decoder 906, ISP 910, and/or GPU 914 and decoder 906, ISP 910, and/or GPU 914 may gate clock or power of regions of VST image data 904, decoded image data 908, and processed image data 912 respectively. Additionally or alternatively, image sensor 902 may provide region indicator 942 to decoder 906, ISP 910, and/or GPU 914. Region indicator 942 may indicate whether to disable (or not) output and/or processing of one or more regions of VST image data 904, decoded image data 908, and/or processed image data 912.

System 900 may determine that a viewer's gaze is focused on virtual content (e.g., according to the temporal check described with regard to gaze checker 932) and determine an amount of overlap between the virtual content and the ROI (and/or middle region) (e.g., according to the spatial check described with regard to overlap checker 934). Further, system 900 may, based on the temporal check and/or spatial check, determine to gate the ROI and/or the middle region. System 900 may provide region indicator 938 to image sensor 902. Region indicator 938 may instruct image sensor 902 to disable output of the redundant region (e.g., the ROI or middle region that will be overlapped by virtual content in image data 916). Additionally or alternatively, system 900 may inform decoder 906, ISP 910, and/or GPU 914 to gate clock or power of the redundant region's pipeline.

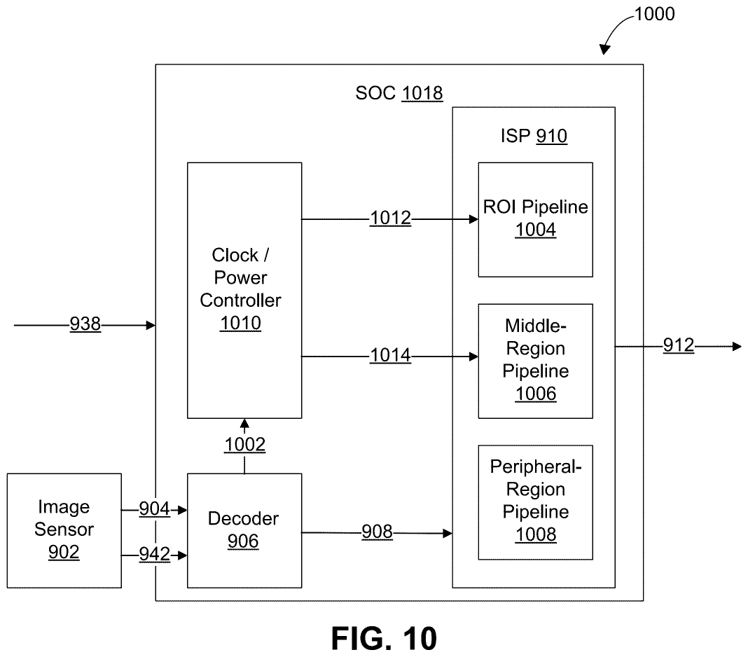

FIG. 10 is a block diagram illustrating an example system 1000 for processing foveated image data, according to various aspects of the present disclosure. In general, decoder 906 may decode VST image data 904 from image sensor 902 to generate decoded image data 908 and ISP 910 may process decoded image data 908 to generate processed image data 912. Additionally, according to various aspects of the present disclosure, ISP 910 may process decoded image data 908 based on regions of VST image data 904 that are to be replaced, for example, by virtual content.

Image sensor 902 of FIG. 10 may be the same as, may be substantially similar to, and/or may perform the same, or substantially the same, operations as image sensor 902 of FIG. 9. VST image data 904 of FIG. 10 may be the same as, or may be substantially similar to, VST image data 904 of FIG. 9.

Decoder 906 of FIG. 10 may be the same as, may be substantially similar to, and/or may perform the same, or substantially the same, operations as decoder 906 of FIG. 9. Additionally, in some aspects, decoder 906 may generate region indicator 1002 and provide region indicator 1002 to clock/power controller 1010. Region indicator 1002 may be, may include, or may be substantially similar to region indicator 942 and/or region indicator 938. Decoded image data 908 of FIG. 10 may be the same as, or may be substantially similar to, decoded image data 908 of FIG. 9.

ISP 910 of FIG. 10 may be the same as, may be substantially similar to, and/or may perform the same, or substantially the same, operations as ISP 910 of FIG. 9. Additionally, in FIG. 10, ISP 910 is illustrated as including separate processing pipelines from processing separate regions of decoded image data 908. As an example, ISP 910 includes a ROI pipeline 1004 for processing ROI image data, such as ROI 402 of FIG. 4. Additionally, ISP 910 includes a middle-region pipeline 1006 for processing middle-region image data, such as middle region 404 of FIG. 4. Additionally, ISP 910 includes a peripheral-region pipeline 1008 for processing peripheral-region image data, such as peripheral region 406 of FIG. 4. Each of ROI pipeline 1004, middle-region pipeline 1006, and peripheral-region pipeline 1008 may perform the same, substantially the same, or different operations on their respective input image data. For example, ROI pipeline 1004, middle-region pipeline 1006, and middle-region pipeline 1006 may reduce noise in an ROI of decoded image data 908, a middle region of decoded image data 908, and a peripheral region of decoded image data 908 respectively. Processed image data 912 of FIG. 10 may be the same as, or may be substantially similar to, processed image data 912 of FIG. 9.

Clock/power controller 1010 may control a clock signal and/or power provided to ISP 910. Clock/power controller 1010 may provide separate clock signals and/or power to separate processing pipelines of ISP 910. For example, clock/power controller 1010 may generate ROI clock/power 1012 for and/or provide ROI clock/power 1012 to ROI pipeline 1004. Additionally clock/power controller 1010 may generate middle-region clock/power 1014 for and/or provide middle-region clock/power 1014 to middle-region pipeline 1006.

The clock signal and/or power provided to each pipeline of ISP 910 may determine whether the respective pipeline operates. For example, clock/power controller 1010 may disable ROI pipeline 1004 by disabling ROI clock/power 1012. Thus, clock/power controller 1010 may disable processing of ROI image data of decoded image data 908 at ISP 910 based on an indication (e.g., region indicator 1002 or region indicator 938) that the ROI image data will be replaced (e.g., by GPU 914). Additionally, clock/power controller 1010 may disable processing of middle-region image data of decoded image data 908 at ISP 910 based on an indication (e.g., region indicator 1002 or region indicator 938) that the middle-region image data will be replaced (e.g., by GPU 914).

In some aspects, clock/power controller 1010 may determine ROI clock/power 1012 and/or middle-region clock/power 1014 based on region indicator 1002 (e.g., an indication generated by decoder 906). In other aspects, clock/power controller 1010 may determine ROI clock/power 1012 and/or middle-region clock/power 1014 based on region indicator 938 (e.g., an indication generated by region disabler 936).

In some aspects, region indicator 942 may be a separate signal from VST image data 904. In other aspects, region indicator 942 may be, or may be included in, header information of VST image data 904. For example, VST image data 904 may be configured to include a header indicating whether an ROI, and/or one or more middle regions of VST image data 904 are to be processed.

To maintain system synchronization (e.g., of system 900), system 1000 includes a data flow between image sensor 902 and SOC 1018 (which includes ISP 910). For example, region disabler 936 may sends a region indicator 938 for fovea and middle regions to image sensor 902. Image sensor 902 may send each frame of VST image data 904 with a header (e.g., a new MIPI embedded packet) including information regarding whether a fovea and/or one or more middle-regions are included for that frame. Decoder 906 decodes packets of VST image data 904. Decoder 906 may pass the information regarding whether fovea and/or one or more middle-regions are included in VST image data 904 to clock/power controller 1010. Clock/power controller 1010 may gate the clock/power of ROI pipeline 1004 and/or middle-region pipeline 1006 in ISP 910 and/or in other computing cores of system 900 that process image data (e.g., GPU 914). The scheme of system 1000 also ensures there are no frame-drops (as image sensor 902 and ISP 910 remain in sync).

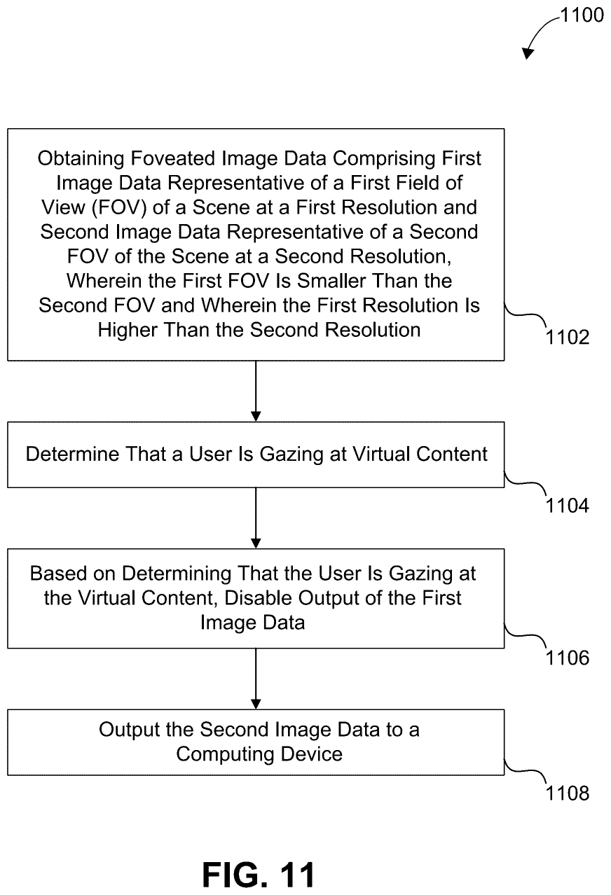

FIG. 11 is a flow diagram illustrating an example process 1100 for extended reality, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors.

At block 1102, a computing device (or one or more components thereof) may obtain foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution. For example, system 900 may obtain VST image data 904, which may include pixels of an ROI (e.g., ROI 402, ROI 702, or ROI 802) and pixels of a peripheral region (e.g., peripheral region 406, peripheral region 706, or peripheral region 806). The pixels of the ROI may represent a smaller field of view than the pixels of the peripheral region. For example, ROI 402 may represent a smaller field of view than peripheral region 406. ROI 402 may have a higher resolution than peripheral region 406.

In some aspects, the computing device (or one or more components thereof) may capture the first image data at an image sensor; and capture the second image data at the image sensor. For example, image sensor 902 may capture VST image data 904, including the ROI (e.g., ROI 402) and the peripheral region (e.g., peripheral region 406).

At block 1104, the computing device (or one or more components thereof) may determine that a user is gazing at virtual content. For example, system 900 may use gaze checker 932 and overlap checker 934 to determine if a user is gazing at virtual content (e.g., to determine if a user is gazing at virtual content 708 or virtual content 808).

In some aspects, to determine that the user is gazing at the virtual content, the computing device (or one or more components thereof) may track a gaze of the user; and determine that the gaze of the user corresponds to a position of the virtual content for a threshold time duration. For example, eye tracker 922 may track a gaze of the user. Additionally or alternatively, gaze predictor 928 may predict a gaze of the user (e.g., gaze position 930). Overlap checker 934 may compare gaze position 930 with virtual-content position 920 to determine whether the user is gazing at the virtual content. Additionally or alternatively, gaze checker 932 may determine if the user is gazing at the virtual content for a threshold duration of time.

At block 1106, the computing device (or one or more components thereof) may, based on determining that the user is gazing at the virtual content, disable output of the first image data. For example, region disabler 936 generate region indicator 938. Image sensor 902 may, based on region indicator 938, cease capturing pixels of the ROI (e.g., ROI 702, or ROI 802 and middle region 804) or to cease providing the captured pixels of the ROI to decoder 906. Additionally or alternatively, decoder 906 may, based on region indicator 938, cease processing pixels of the ROI (e.g., ROI 702, or ROI 802 and middle region 804) or cease providing the processed pixels of the ROI to ISP 910. Additionally or alternatively, ISP 910 may, based on region indicator 938, cease processing pixels of the ROI (e.g., ROI 702, or ROI 802 and middle region 804) or cease providing the processed pixels of the ROI to GPU 914.

In some aspects, to disable output of the first image data, the at least one processor is configured to disable output of the first image data from the image sensor. Image sensor 902 may, based on region indicator 938, cease capturing pixels of the ROI (e.g., ROI 702, or ROI 802 and middle region 804) or to cease providing the captured pixels of the ROI to decoder 906.

In some aspects, the computing device (or one or more components thereof) may, based on determining that the user is gazing at the virtual content, disable processing of the first image data; and process the second image data. For example, region disabler 936 generate region indicator 938. Decoder 906 may, based on region indicator 938, cease processing pixels of the ROI (e.g., ROI 702, or ROI 802 and middle region 804) or cease providing the processed pixels of the ROI to ISP 910. Additionally or alternatively, ISP 910 may, based on region indicator 938, cease processing pixels of the ROI (e.g., ROI 702, or ROI 802 and middle region 804) or cease providing the processed pixels of the ROI to GPU 914. Decoder 906, ISP 910, and/or GPU 914 may continue processing pixels of the peripheral region (e.g., peripheral region 706 and middle region 704 or peripheral region 806).

In some aspects, to disable output of the first image data, the computing device (or one or more components thereof) may cause a transmitter to disable transmission of the first image data. For example, system 900 may determine to cease transmitting ROI image data, based on region indicator 938. For example, system 900 may transmit middle region 704 and peripheral region 706 but not ROI 702 or peripheral region 806 but not ROI 802 and not middle region 804.

In some aspects, the computing device (or one or more components thereof) may cause at least one transmitter to transmit an indication that output of the first image data is disabled. For example, system 900 may transmit an indication (e.g., a header) indicating that ROI 702 or ROI 802 and middle region 804 will not be transmitted.

In some aspects, the computing device (or one or more components thereof) may determine a region of interest (ROI) based on a gaze of the user; and determine to disable output of the first image data further based on determining that a position of the virtual content overlaps with at least a portion of the ROI. For example, system 900 may determine an ROI (e.g., ROI 702 or ROI 802) based on gaze position 930. Overlap checker 934 may determine that the ROI overlaps with virtual content (e.g., virtual content 708 or virtual content 808). Based on determining that the ROI overlaps with virtual content, system 900 may cause image sensor 902 to disable capturing the ROI, cause decoder 906 to disable decoding pixels of the ROI, cause ISP 910 to disable processing pixels of the ROI, and/or cause GPU 914 to disable processing pixels of the ROI.

In some aspects, a computing device (or one or more components thereof) may determine a region of interest (ROI) based on a gaze of the user; and determine to disable output of the first image data further based on determining that a position of the virtual content overlaps a threshold portion of the ROI. For example, system 900 may determine an ROI (e.g., ROI 702 or ROI 802) based on gaze position 930. Overlap checker 934 may determine that virtual content (e.g., virtual content 708 or virtual content 808) overlaps with a threshold portion (e.g., 80% or 90%) of the ROI. Based on determining that virtual content overlaps with a threshold portion of the ROI, system 900 may cause image sensor 902 to disable capturing the ROI, cause decoder 906 to disable decoding pixels of the ROI, cause ISP 910 to disable processing pixels of the ROI, and/or cause GPU 914 to disable processing pixels of the ROI.

At block 1108, the computing device (or one or more components thereof) may output the second image data to a computing device. For example, GPU 914 may output image data 916 (e.g., to display 918). As another example, system 900 may transmit image data 916. As another example, system 900 may store image data 916 (e.g., at a memory location) for processing by another computing device. As an example, image data 916 may include middle region 704 and peripheral region 706, as processed by ISP 910 and GPU 914, but not ROI 702. As another example, image data 916 may include peripheral region 806, as processed by ISP 910 and GPU 914, but not ROI 802 and middle region 804.

In some aspects, the computing device (or one or more components thereof) may display the virtual content at a display. For example, image data 916 may include virtual content.

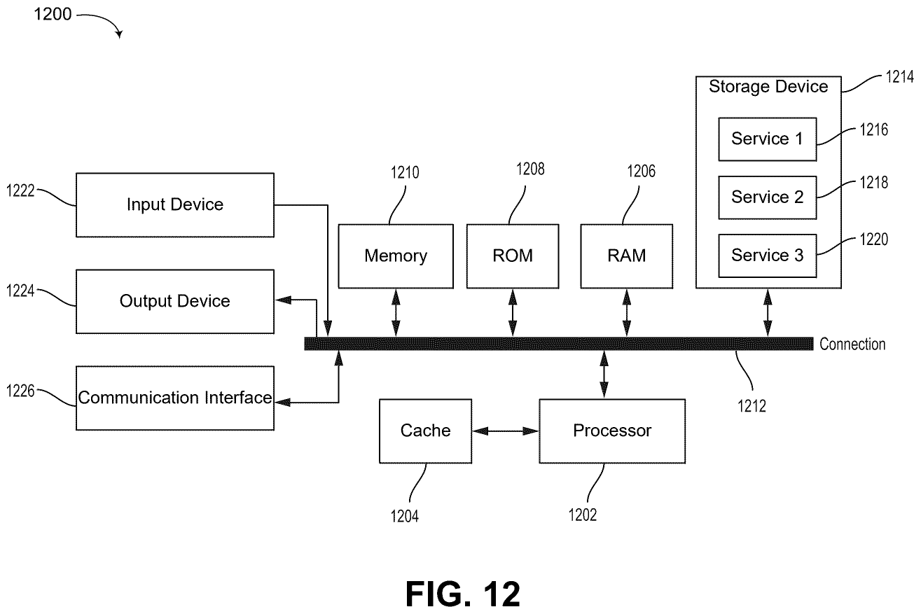

In some examples, as noted previously, the methods described herein (e.g., process 1100 of FIG. 11, and/or other methods described herein) can be performed, in whole or in part, by a computing device or apparatus. In one example, one or more of the methods can be performed by system 900 of FIG. 9, or by another system or device. In another example, one or more of the methods (e.g., process 1100, and/or other methods described herein) can be performed, in whole or in part, by the computing-device architecture 1200 shown in FIG. 12. For instance, a computing device with the computing-device architecture 1200 shown in FIG. 12 can include, or be included in, the components of the system 900 and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 900 and/or other devices, modules, or systems described herein. Additionally or alternatively, computing-device architecture 1200 may be configured to perform process 1100, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for foveated imaging, the apparatus comprising: at least one memory; and at least one processor coupled to the at least one memory and configured to: obtain foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; determine that a user is gazing at virtual content; based on determining that the user is gazing at the virtual content, disable output of the first image data; and output the second image data to a computing device.

Aspect 2. The apparatus of Aspect 1, wherein, to determine that the user is gazing at the virtual content, the at least one processor is configured to: track a gaze of the user; and determine that the gaze of the user corresponds to a position of the virtual content for a threshold time duration.

Aspect 3. The apparatus of any of Aspects 1 or 2, wherein the at least one processor is configured to: determine a region of interest (ROI) based on a gaze of the user; and determine to disable output of the first image data further based on determining that a position of the virtual content overlaps with at least a portion of the ROI.

Aspect 4. The apparatus of any of Aspects 1 to 3, wherein the at least one processor is configured to: determine a region of interest (ROI) based on a gaze of the user; and determine to disable output of the first image data further based on determining that a position of the virtual content overlaps a threshold portion of the ROI.

Aspect 5. The apparatus of any of Aspects 1 to 4, wherein the at least one processor is configured to: capture the first image data at an image sensor; and capture the second image data at the image sensor.

Aspect 6. The apparatus of Aspect 5, wherein, to disable output of the first image data, the at least one processor is configured to disable output of the first image data from the image sensor.

Aspect 7. The apparatus of any of Aspects 1 to 6, wherein the at least one processor is configured to: based on determining that the user is gazing at the virtual content, disable processing of the first image data; and process the second image data.

Aspect 8. The apparatus of any of Aspects 1 to 7, wherein, to disable output of the first image data, the at least one processor is configured to cause a transmitter to disable transmission of the first image data.

Aspect 9. The apparatus of any of Aspects 1 to 8, the at least one processor is configured to cause at least one transmitter to transmit an indication that output of the first image data is disabled.

Aspect 10. The apparatus of any of Aspects 1 to 9, wherein the at least one processor is configured to display the virtual content at a display.

Aspect 11. A method for foveated imaging, the method comprising: obtaining foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution; determining that a user is gazing at virtual content; based on determining that the user is gazing at the virtual content, disabling output of the first image data; and outputting the second image data to a computing device.

Aspect 12. The method of Aspect 11, wherein determining that the user is gazing at the virtual content comprises: tracking a gaze of the user; and determining that the gaze of the user corresponds to a position of the virtual content for a threshold time duration.

Aspect 13. The method of any of Aspects 11 or 12, further comprising: determining a region of interest (ROI) based on a gaze of the user; and determining to disable output of the first image data further based on determining that a position of the virtual content overlaps with at least a portion of the ROI.

Aspect 14. The method of any of Aspects 11 to 13, further comprising: determining a region of interest (ROI) based on a gaze of the user; and determining to disable output of the first image data further based on determining that a position of the virtual content overlaps a threshold portion of the ROI.

Aspect 15. The method of any of Aspects 11 to 14, further comprising: capturing the first image data at an image sensor; and capturing the second image data at the image sensor.

Aspect 16. The method of Aspect 15, wherein disabling output of the first image data comprises disabling output of the first image data from the image sensor.

Aspect 17. The method of any of Aspects 11 to 16, further comprising: based on determining that the user is gazing at the virtual content, disabling processing of the first image data; and processing the second image data.

Aspect 18. The method of any of Aspects 11 to 17, wherein disabling output of the first image data comprises causing a transmitter to disable transmission of the first image data.

Aspect 19. The method of any of Aspects 11 to 18, further comprising transmitting an indication that output of the first image data is disabled.

Aspect 20. The method of any of Aspects 11 to 19, further comprising displaying the virtual content at a display.

Aspect 21. A non-transitory computer-readable medium having stored thereon instructions that, when executed by at least one processor, cause the at least one processor to perform operations according to any of Aspects 11 to 20.

Aspect 22. An apparatus for foveated imaging, the apparatus including one or more means for performing operations according to any of Aspects 11 to 20.

What is claimed is:

1. An apparatus for foveated imaging, the apparatus comprising:
at least one memory; and
at least one processor coupled to the at least one memory and configured to:
obtain foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution;
determine that a user is gazing at virtual content;
based on determining that the user is gazing at the virtual content, disable output of the first image data; and
output the second image data to a computing device.

2. The apparatus of claim 1, wherein, to determine that the user is gazing at the virtual content, the at least one processor is configured to:
track a gaze of the user; and
determine that the gaze of the user corresponds to a position of the virtual content for a threshold time duration.

3. The apparatus of claim 1, wherein the at least one processor is configured to:
determine a region of interest (ROI) based on a gaze of the user; and
determine to disable output of the first image data further based on determining that a position of the virtual content overlaps with at least a portion of the ROI.

4. The apparatus of claim 1, wherein the at least one processor is configured to:
determine a region of interest (ROI) based on a gaze of the user; and
determine to disable output of the first image data further based on determining that a position of the virtual content overlaps a threshold portion of the ROI.

5. The apparatus of claim 1, wherein the at least one processor is configured to:
capture the first image data at an image sensor; and
capture the second image data at the image sensor.

6. The apparatus of claim 5, wherein, to disable output of the first image data, the at least one processor is configured to disable output of the first image data from the image sensor.

7. The apparatus of claim 1, wherein the at least one processor is configured to:
based on determining that the user is gazing at the virtual content, disable processing of the first image data; and
process the second image data.

8. The apparatus of claim 1, wherein, to disable output of the first image data, the at least one processor is configured to cause a transmitter to disable transmission of the first image data.

9. The apparatus of claim 1, the at least one processor is configured to cause at least one transmitter to transmit an indication that output of the first image data is disabled.

10. The apparatus of claim 1, wherein the at least one processor is configured to display the virtual content at a display.

11. A method for foveated imaging, the method comprising:
obtaining foveated image data comprising first image data representative of a first field of view (FOV) of a scene at a first resolution and second image data representative of a second FOV of the scene at a second resolution, wherein the first FOV is smaller than the second FOV and wherein the first resolution is higher than the second resolution;
determining that a user is gazing at virtual content;
based on determining that the user is gazing at the virtual content, disabling output of the first image data; and
outputting the second image data to a computing device.

12. The method of claim 11, wherein determining that the user is gazing at the virtual content comprises:
tracking a gaze of the user; and
determining that the gaze of the user corresponds to a position of the virtual content for a threshold time duration.

13. The method of claim 11, further comprising:
determining a region of interest (ROI) based on a gaze of the user; and
determining to disable output of the first image data further based on determining that a position of the virtual content overlaps with at least a portion of the ROI.

14. The method of claim 11, further comprising:
determining a region of interest (ROI) based on a gaze of the user; and
determining to disable output of the first image data further based on determining that a position of the virtual content overlaps a threshold portion of the ROI.

15. The method of claim 11, further comprising:
capturing the first image data at an image sensor; and
capturing the second image data at the image sensor.

16. The method of claim 15, wherein disabling output of the first image data comprises disabling output of the first image data from the image sensor.

17. The method of claim 11, further comprising:
based on determining that the user is gazing at the virtual content, disabling processing of the first image data; and
processing the second image data.

18. The method of claim 11, wherein disabling output of the first image data comprises causing a transmitter to disable transmission of the first image data.

19. The method of claim 11, further comprising transmitting an indication that output of the first image data is disabled.

20. The method of claim 11, further comprising displaying the virtual content at a display.
